(19) United States
(12) Patent Application Publication
(10) Pub. No.: US 2010/0060268 A1
(43) Pub. Date: Mar. 11, 2010

(54) ANGLE SENSOR

(75) Inventor: Ichiro TOKUNAGA, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/536,399

(22) Filed: Aug. 5, 2009

(30) Foreign Application Priority Data
Sep. 5, 2008 (JP) 2008-228881
May 25, 2009 (JP) 2009-125080

(51) Int. Cl. G01B 7/30

(52) U.S. Cl. 324/207.2; 324/207.25

(57) ABSTRACT

A magnet which is attached to a rotary body and which is rotatable together with the rotary body; an annular yoke which extends annularly to surround an outer peripheral surface around a rotary shaft of the magnet and in which a notch portion is formed in a part in the extending direction; and a hall element which is disposed in the notch portion and which detects the strength of a magnetic field in the radial direction of the magnet and detects the strength of a magnetic field in the rotation angle direction perpendicular to the magnetic field in the radial direction of the magnet are provided. The angle of rotation of the magnet is calculated on the basis of signals corresponding to the magnetic field strengths in the radial direction and rotation angle direction detected by the hall element.

### CROSS REFERENCE TO RELATED APPLICATION

The present application contains subject matter related to Japanese Patent Application JP2008-228881 filed in the Japanese Patent Office on Sep. 5, 2008, the entire contents of which being incorporated herein by reference.

### BACKGROUND

1. Technical Field

The present invention relates to an angle sensor, for example, an angle sensor to which high angle detection precision is requested.

2. Related Art

The angle sensors in which a magnet having a circular shape is disposed around a rotary shaft and two hall elements are disposed at the positions, which are shifted from each other by 90°, near the outer periphery of the magnet and which calculates the angle of rotation of the rotary shaft on the basis of the magnetic field strength in the radial direction detected by each hall element have been proposed in the related art (for example, refer to JP-A-2005-140557 and JP-A-2002-506530).

In the angle sensors disclosed in JP-A-2005-140557 and JP-A-2002-506530, since the two hall elements are disposed at the different positions, there has been a problem that it is difficult to secure the positional relationship on the basis of the relationship with the magnet and accordingly, the high angle detection precision cannot be secured. In order to solve the problem, an angle sensor in which a high angle detection precision is secured by disposing a hall element at a single position in the peripheral direction near the outer periphery of the magnet has been considered by this applicant. This angle sensor secures the high angle detection precision by detecting two signals, of which the phase difference according to the magnetic field strengths in the radial direction and rotation angle direction is 90°, using the hall element, performing an electrical amplitude correction such that the amplitudes of the two signals become equal, and calculating the angle of rotation of the magnet on the basis of the corrected signals.

In the angle sensor, however, the strength of the magnetic field which acts on the hall element changes according to the rotational position of the magnet. For this reason, when the mounting accuracy of the hall element is not good, for example, when the hall element is disposed to be slightly inclined with respect to the magnet, the phase difference between the signals corresponding to the magnetic field strengths in the radial direction and rotation angle direction detected by the hall element deviates from 90°. In this case, since the angle detection is performed on the basis of the signals between which phase deviation has occurred, the angle error has been generated.

In addition, in the above angle sensor, the electrical amplitude correction is performed such that the signals corresponding to the magnetic field strengths in the radial direction and rotation angle direction have the same amplitude. For this reason, there is a problem that the control configuration becomes complicated.

### SUMMARY

In view of the above, it is an object of the invention to provide an angle sensor which is capable of securing a high angle detection precision regardless of the mounting accuracy of a magnetic detection element and which has a simple control configuration.

According to an aspect of the invention, there is provided an angle sensor including: a magnet which is attached to a rotary body and which is rotatable together with the rotary body; an annular yoke which extends annularly to surround an outer peripheral surface around a rotary shaft of the magnet and in which a notch portion is formed in a part in the extending direction; a magnetic detection element which is disposed in the notch portion and which detects the strength of a magnetic field in the radial direction of the magnet and detects the strength of a magnetic field in the rotation angle direction perpendicular to the magnetic field in the radial direction of the magnet; and an operation unit that calculates the angle of rotation of the magnet on the basis of signals corresponding to the magnetic field strengths in the radial direction and rotation angle direction detected by the magnetic detection element.

According to this configuration, the magnetic path is formed by the annular yoke in which the notch portion is formed. Accordingly, for example, when the magnetic pole of the magnet is located in the linear shape of the magnetic detection element, some magnetic flux is pulled from the notch portion to the annular yoke. As a result, the magnetic flux passing through the magnetic detection element is decreased. When the magnet has rotated by 90° from the position, the magnetic flux is introduced by the annular yoke. As a result, the magnetic flux passing through the magnetic detection element is increased. Therefore, by forming a notch portion such that the strength of the magnetic field which acts on the magnetic detection element is constant regardless of the rotational position of the magnet, the phase difference between the signals corresponding to the magnetic field strengths in the radial direction and the rotation angle direction detected by the magnetic detection element can be set to 90° even if the magnetic detection element is inclined and attached. As a result, a high angle detection precision can be secured regardless of the mounting accuracy of the magnetic detection element.

In addition, since the electrical amplitude correction becomes unnecessary by forming the notch portion such that the strength of the magnetic field which acts on the magnetic detection element is constant regardless of the rotational position of the magnet, the angle sensor can be made to have a simple control configuration.

Moreover in the angle sensor according to the aspect of the invention, preferably, the width of the gap in the notch portion is set such that the amplitude ratio between the signals corresponding to the magnetic field strengths in the radial direction and rotation angle direction detected by the magnetic detection element becomes 1.

According to this configuration, since the amplitude of the signal corresponding to the magnetic intensity in the radial direction detected by the magnetic detection element is equal to the amplitude of the signal corresponding to the magnetic intensity in the rotation angle direction, the width of the gap in the notch portion can be set such that the strength of the magnetic field which acts on the magnetic detection element is constant regardless of the rotational position of the magnet.

Moreover in the angle sensor according to the aspect of the invention, preferably, the annular yoke is formed in a circular shape and the width of the gap in the notch portion is ⅛ to 1/12 of the central diameter of the annular yoke.

Moreover in the angle sensor according to the aspect of the invention, preferably, the width of the gap of the notch portion is 1/10 of the central diameter of the annular yoke.

According to this configuration, by determining the central diameter of the annular yoke, it is possible to determine the appropriate width of the gap in the notch portion such that the strength of the magnetic field, which acts on the magnetic detection element according to the rotation of the magnet, is constant. In addition, the central diameter of the annular yoke is a half of the sum of the external diameter and the internal diameter of the annular yoke.

According to another aspect of the invention, there is provided an angle sensor including: a magnet which is attached to a rotary body and which is rotatable together with the rotary body; an annular yoke which extends annularly to surround an outer peripheral surface around a rotary shaft of the magnet and in which a plurality of notch portions is formed in the extending direction; a magnetic detection element which is disposed in one of the plurality of notch portions and which detects the strength of a magnetic field in the radial direction of the magnet and detects the strength of a magnetic field in the rotation angle direction perpendicular to the magnetic field in the radial direction of the magnet; and an operation unit that calculates the angle of rotation of the magnet on the basis of signals corresponding to the magnetic field strengths in the radial direction and rotation angle direction detected by the magnetic detection element.

According to this configuration, the magnetic path is formed by the annular yoke in which the plurality of notch portions is formed. Accordingly, for example, when the magnetic pole of the magnet is located in the linear shape of the magnetic detection element, some magnetic flux is pulled from the notch portions to the annular yoke. As a result, the magnetic flux passing through the magnetic detection element is decreased. When the magnet has rotated by 90° from the position, the magnetic flux is introduced by the annular yoke. As a result, the magnetic flux passing through the magnetic detection element is increased. Therefore, by forming the notch portions such that the strength of the magnetic field which acts on the magnetic detection element is constant regardless of the rotational position of the magnet, the phase difference between the signals corresponding to the magnetic field strengths in the radial direction and rotation angle direction detected by the magnetic detection element can be set to 90° even if the magnetic detection element is inclined and attached. As a result, the high angle detection precision can be secured regardless of the mounting accuracy of the magnetic detection element.

In addition, since the electrical amplitude correction becomes unnecessary by forming the notch portions such that the strength of the magnetic field which acts on the magnetic detection element is constant regardless of the rotational position of the magnet, the angle sensor can be made to have a simple control configuration.

In addition, the biasing of the magnetic flux density in the annular yoke can be reduced by forming the plurality of notch portions such that the magnetic resistance of the magnetic path in which the magnetic flux flows in one direction of the annular yoke is approximately equal to the magnetic resistance of the magnetic path in which the magnetic flux flows in the opposite direction. Accordingly, it is possible to improve the detection sensitivity by suppressing the decrease in the magnetic flux, which acts on the magnetic detection element, and to prevent leakage of the magnetic flux caused by the saturation of the yoke.

Moreover, in the angle sensor according to the aspect of the invention, preferably, the plurality of notch portions is formed in the annular yoke such that the magnetic resistance of a magnetic path in which the magnetic flux flows in one direction of the annular yoke is approximately equal to the magnetic resistance of a magnetic path in which the magnetic flux flows in the opposite direction.

According to this configuration, since the biasing of the magnetic flux density in the annular yoke can be reduced, it is possible to further improve the detection sensitivity by suppressing the decrease in the magnetic flux, which acts on the magnetic detection element, and to prevent leakage of the magnetic flux caused by the saturation of the yoke.

Moreover, in the angle sensor according to the aspect of the invention, preferably, the number of plurality of notch portions is two and the two notch portions are formed at the approximately opposite positions with the rotation center of the magnet interposed therebetween in the annular yoke.

According to this configuration, in the annular yoke, the magnetic resistance of the magnetic path in which the magnetic flux flows in one direction can be made approximately equal to the magnetic resistance of the magnetic path in which the magnetic flux flows in the opposite direction.

Moreover, in the angle sensor according to the aspect of the invention, preferably, the widths of the gaps in the two notch portions are set such that the amplitude ratio between the signals corresponding to the magnetic field strengths in the radial direction and rotation angle direction detected by the magnetic detection element becomes 1.

According to this configuration, since the amplitude of the signal corresponding to the magnetic intensity in the radial direction detected by the magnetic detection element is equal to the amplitude of the signal corresponding to the magnetic intensity in the rotation angle direction, the widths of the gaps in the plurality of notch portions can be set such that the strength of the magnetic field which acts on the magnetic detection element is constant regardless of the rotational position of the magnet.

Moreover, in the angle sensor according to the aspect of the invention, preferably, the annular yoke is formed in a circular shape and the widths of the gaps of the two notch portions are ⅛ to 1/12 of the central diameter of the annular yoke.

According to this configuration, by determining the central diameter of the annular yoke, it is possible to determine the widths of the gaps in the two notch portions such that the strength of the magnetic field, which acts on the magnetic detection element according to the rotation of the magnet, is constant. In addition, the central diameter of the annular yoke is a half of the sum of the external diameter and the internal diameter of the annular yoke.

According to the invention, the high angle detection precision can be secured regardless of the mounting accuracy of the magnetic detection element and the simple control configuration can be realized.

### BRIEF DESCRIPTION OF THE DRAWINGS

FIG. 1 is a view illustrating an embodiment of an angle sensor according to the invention and is a schematic view illustrating the angle sensor;

FIG. 2 is a view illustrating the embodiment of the angle sensor according to the invention and is a functional block diagram of the angle sensor;

FIGS. 3A and 3B are views for explaining the phase error of a detection signal when an angle sensor in a comparative example is used, where FIG. 3A is a view for explaining the magnetic field and FIG. 3B is a view for explaining the maximum magnetic field strength of a Y-direction component of a hall element;

FIG. 4 is a view illustrating the relationship between the output voltage and the phase of the angle sensor in the comparative example;

FIGS. 5A and 5B are views illustrating the embodiment of the angle sensor according to the invention, where FIG. 5A is a view illustrating a state of the magnetic flux when the magnet is located at the initial position and FIG. 5B is a view illustrating a state of the magnetic flux when the magnet is located at the position rotated by 90° from the initial position;

FIG. 6 is a view illustrating the embodiment of the angle sensor according to the invention and is a view illustrating the relationship between the output voltage and the phase of the angle sensor;

FIG. 7 is a view illustrating the embodiment of the angle sensor according to the invention and is a view illustrating the linear characteristic of the angle sensor;

FIG. 8 is a view illustrating the embodiment of the angle sensor according to the invention and is a view illustrating the relationship between the element rotation angle of the hall element and the angle error;

FIG. 9 is a view illustrating the embodiment of the angle sensor according to the invention and is a view illustrating the design of the annular yoke;

FIG. 10 is a view illustrating the embodiment of the angle sensor according to the invention and is a view illustrating the relationship between the width of the gap in the annular yoke shown in FIG. 9 and the amplitude ratio of the output voltages of the Y-direction component and X-direction component of the hall element;

FIG. 11 is a view illustrating another embodiment of the angle sensor according to the invention and is a schematic view illustrating the angle sensor;

FIG. 12 is a view illustrating another embodiment of the angle sensor according to the invention and is a view illustrating the design of the annular yoke;

FIG. 13 is a view for explaining the flow of magnetic flux of the angle sensor in the comparative example;

FIG. 14 is a view illustrating another embodiment of the angle sensor according to the invention and is a view for explaining the flow of magnetic flux of the angle sensor; and

FIGS. 15A and 15B are views illustrating another embodiment of the angle sensor according to the invention and are views illustrating the relationship between the angle of rotation of the angle sensor and the variation width of the magnetic flux density.

### DESCRIPTION OF EXEMPLARY EMBODIMENTS

Hereinafter, embodiments of the invention will be described in detail with reference to the accompanying drawings. In addition, an angle sensor according to the present embodiment is used as an angle sensor to which a high angle detection precision is requested, for example, in order to detect the crank angle in the engine mounted in an automobile or the like. In the following, the case where the angle sensor according to the present embodiment is applied to a crank angle sensor will be described as necessary.

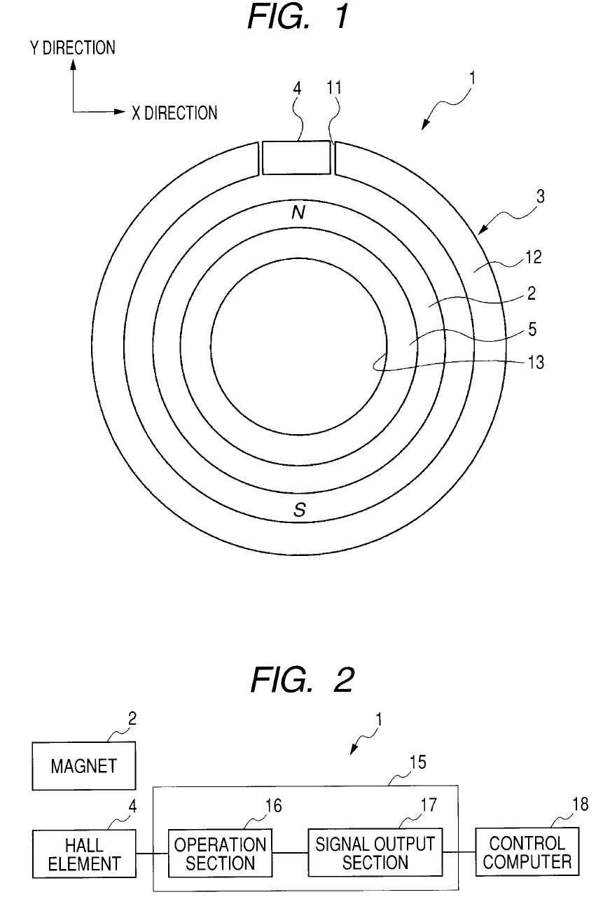

FIG. 1 is a schematic view illustrating the angle sensor according to the embodiment of the invention. As shown in FIG. 1, an angle sensor 1 according to the present embodiment is configured to include: a magnet 2 having a circular shape; an annular yoke 3 which surrounds the outer peripheral surface of the magnet 2 and which has a notch portion 11 formed in a part thereof; and a hall element 4 as a magnetic detection element disposed in the notch portion 11 of the annular yoke 3. A circular mounting member 5 is disposed on the inner peripheral surface of the magnet 2, and a mounting hole 13 through which a crankshaft (not shown) can be inserted is formed in the middle of the mounting member 5.

The magnet 2 is formed in the circular shape and is fixed to the outer peripheral surface of the mounting member 5 so that relative rotation cannot be performed. In addition, N and S poles are magnetized in two places of the magnet 2 which face each other in the radial direction, such that the magnetic field is generated in the periphery in the circular arc shape which starts from the N pole and reaches the S pole through the annular yoke 3.

The annular yoke 3 is formed in the ‘C’ shape in front view by providing the notch portion 11 in a circular portion 12 and is disposed with a fixed gap from the outer peripheral surface of the magnet 2 in the radial direction. In addition, the circular portion 12 and the notch portion 11 of the annular yoke 3 form the magnetic path of the magnetic field generated from the magnet 2, such that the strength of the magnetic field which acts on the hall element 4 is constant regardless of the rotational position of the magnet 2. In addition, details of the magnetic path formed by the annular yoke 3 will be described later.

The hall element 4 is disposed in the notch portion 11 of the annular yoke 3 and detects the strength of the magnetic field generated from the magnet 2. Here, the hall element 4 is configured to be able to detect the magnetic field strength of the Y-direction component, which is the radial direction of the magnet 2, and to detect the magnetic field strength of the X-direction component, which is the rotation angle direction perpendicular to the magnetic field of the magnet 2 in the radial direction.

The angle sensor 1 according to the present embodiment has such a configuration, and detects the magnetic field strength of the Y-direction component and the magnetic field strength of the X-direction component according to the rotation of the magnet 2 by using the hall element 4 and calculates the arc tangent of the detected signal to thereby calculate the angle of rotation (that is, the angle of rotation of an object to be detected, such as a crankshaft) of the magnet 2.

Hereinafter, a functional block diagram of the angle sensor according to the present embodiment will be described. FIG. 2 is a functional block diagram of the angle sensor according to the present embodiment. In addition, the functional block diagram shown in FIG. 2 is simplified to describe the invention, and not only the functions shown in FIG. 2 but also other functions may be included.

As shown in FIG. 2, the angle sensor 1 according to the present embodiment includes an IC unit 15 connected to the hall element 4. This IC unit 15 has an operation section 16, which calculates the angle of rotation of the magnet 2 by calculating the arc tangent from the detection signal from the hall element 4, and a signal output section 17, which outputs to the outside the angle of rotation of the magnet 2 calculated by the operation section 16. The signal from the IC unit 15 is output to a control computer 18 which controls the entire vehicle, for example.

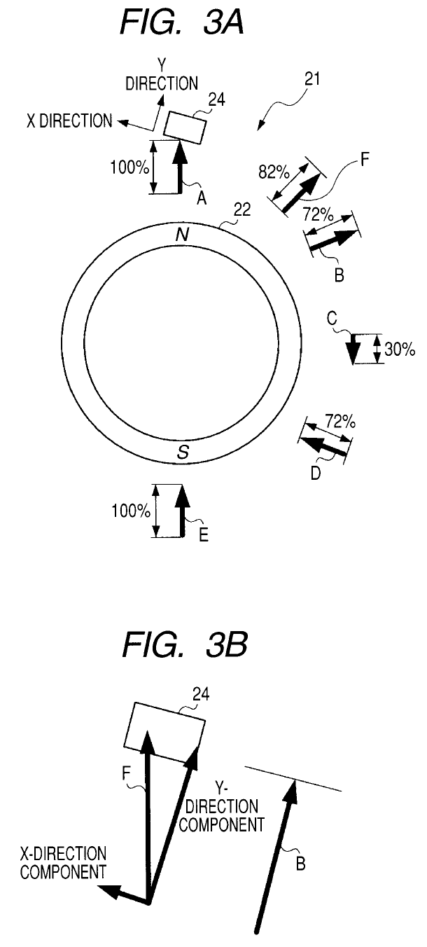

Referring to FIGS. 3 to 8, the angle sensor according to the present embodiment and a comparative example for comparison with the angle sensor according to the present embodiment will be described. First, the cause of degrading of the angle detection precision of an angle sensor in the comparative example will be described.

FIGS. 3A and 3B are views for explaining the phase error of a detection signal when the angle sensor in the comparative example is used, where FIG. 3A is a view for explaining the magnetic field and FIG. 3B is a view for explaining the maximum magnetic field strength of a Y-direction component of a hall element. In addition, an angle sensor 21 in the comparative example shown in FIG. 3 is different from the angle sensor 1 according to the present embodiment in that the annular yoke 3 is not provided and a correction section, which performs electrical amplitude correction such that the amplitudes of signals corresponding to the magnetic field strengths in the Y-direction component and X-direction component become equal, is provided. In addition, arrows A, B, C, D, E, and F indicate the magnetic vectors in the magnetic field. In FIG. 3, six arrows are shown for the convenience of explanation.

As shown in FIG. 3A, in the angle sensor 21 of the comparative example, when the N pole of a magnet 22 is located at the initial position facing a hall element 24, the magnetic field strength becomes maximum near the N pole as indicated by the magnetic vector A. The magnetic field strength is reduced to 72% at the position rotated by about 45° from the N pole as indicated by the magnetic vector B and is reduced to 30% at the position rotated by 90° from the N pole as indicated by the magnetic vector C. Moreover, the magnetic field strength is increased to 72% again at the position rotated by about 135° from the N pole as indicated by the magnetic vector D and becomes the maximum at the position rotated by about 180° from the N pole as indicated by the magnetic vector E. Thus, the magnetic field strength becomes the maximum near both the poles and becomes the minimum at the middle position of both the poles in the magnetic field.

In the angle sensor 21 of the comparative example, for example, when a Y-direction sensing surface of the hall element 24 is inclined and disposed so as to be perpendicular to the magnetic vector B, the magnetic field strength of the Y-direction component detected by the hall element 24 does not maximize the Y-direction component of the magnetic vector B perpendicular to the Y-direction sensing surface of the hall element 24 but maximizes the Y-direction component of the magnetic vector F located closer to the N pole than the magnetic vector B is, as shown in FIG. 3B. In this case, since the X-direction component of the magnetic vector F does not become 0, the phase deviation occurs between signals corresponding to the magnetic field strengths of the Y-direction component and X-direction component detected by the hall element 24.

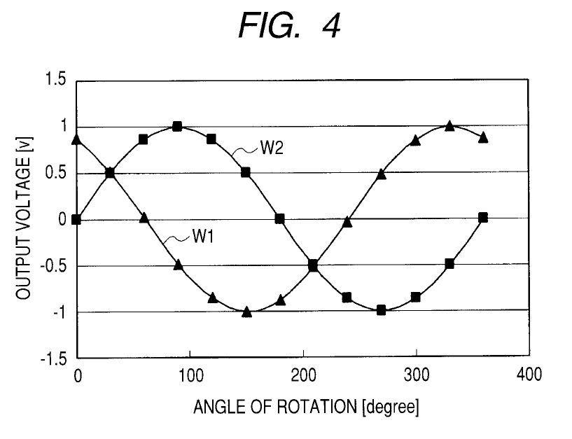

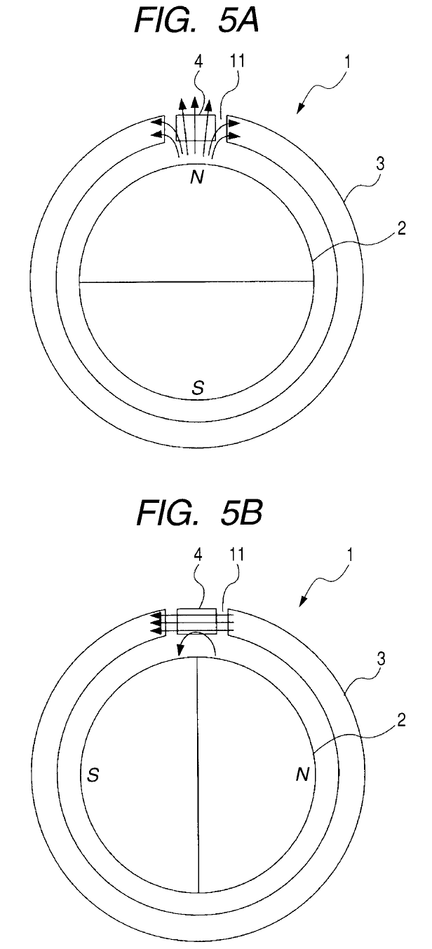

Hereinafter, the relationship between the output voltage and the phase when the hall element is inclined and disposed will be described with reference to FIG. 4. FIG. 4 is a view illustrating the relationship between the output voltage and the phase of the angle sensor in the comparative example. Moreover, in FIG. 4, the vertical axis indicates the output voltage and the horizontal axis indicates the angle of rotation of the magnet. In addition, a solid line W1 indicates an output voltage signal corresponding to the magnetic field strength of the Y-direction component, a solid line W2 indicates an output voltage signal corresponding to the magnetic field strength of the X-direction component, and the amplitudes of the solid lines W1 and W2 have been electrically corrected by the correction section (not shown).

As shown in FIG. 4, the magnetic field strength of the Y-direction component detected by the hall element 24 becomes an output voltage signal whose phase is shifted by φ from the cosine wave which has a maximum output voltage of 1 [v] and a minimum output voltage of −1 [v]. On the other hand, the magnetic field strength of the X-direction component detected by the hall element 24 becomes an output voltage signal of the sine wave which has a maximum output voltage of 1 [v] and a minimum output voltage of −1 [v]. Since the magnetic field strength of the X-direction component does not become 0 when the magnetic field strength of the Y-direction component detected by the hall element 24 is maximum, the phase difference of ‘90°+φ’ occurs between the output voltage signal corresponding to the magnetic field strength of the Y-direction component and the output voltage signal corresponding to the magnetic field strength of the X-direction component. Thus, in the case of the angle sensor 21 in the comparative example, the strength of the magnetic field which acts on the hall element 24 changes with the rotational position of the magnet 22. Accordingly, even if the amplitudes of the signals corresponding to the magnetic field strengths in the Y-direction component and X-direction component are electrically corrected, the phase deviation caused by the mounting error of the hall element 24 occurs. As a result, the angle detection precision is degraded.

Next, the angle detection precision of the angle sensor according to the present embodiment will be described. FIGS. 5A and 5B are views illustrating the state of magnetic flux which acts on the hall element, where FIG. 5A shows the case where the magnet is located at the initial position and FIG. 5B shows the case where the magnet has rotated by 90° from the initial position. Moreover, in FIGS. 5A and 5B, only the magnetic flux near the notch portion 11 is shown.

As shown in FIG. 5A, when the magnet 2 is located at the initial position, the magnetic flux is pulled to the annular yoke 3 through the notch portion 11. Accordingly, the magnetic flux passing through the Y-direction sensing surface of the hall element 4 is decreased. On the other hand, as shown in FIG. 5B, when the magnet 2 is located at the position rotated by 90° from the initial position, the magnetic flux is introduced by the annular yoke 3. Accordingly, the magnetic flux passing through the X-direction sensing surface of the hall element 4 is increased. Thus, the annular yoke 3 forms the magnetic path such that the magnetic flux is pulled to the annular yoke 3 in a portion where the magnetic field strength is large and the leakage of the magnetic flux is prevented in a portion where the magnetic field strength is small.

Thus, the annular yoke 3 is formed so that the magnetic field strength (size of the magnetic vector) which acts on the hall element 4 is constant regardless of the rotational position of the magnet 2. Accordingly, even if the hall element 4 is inclined and disposed, the magnetic field strength of the Y-direction component detected by the hall element 4 maximizes the Y-direction component of the magnetic vector perpendicular to the Y-direction sensing surface of the hall element 4. In this case, since the X-direction component of the magnetic vector becomes 0, the phase deviation does not occur between the signals corresponding to the magnetic field strengths of the Y-direction component and X-direction component detected by the hall element 4.

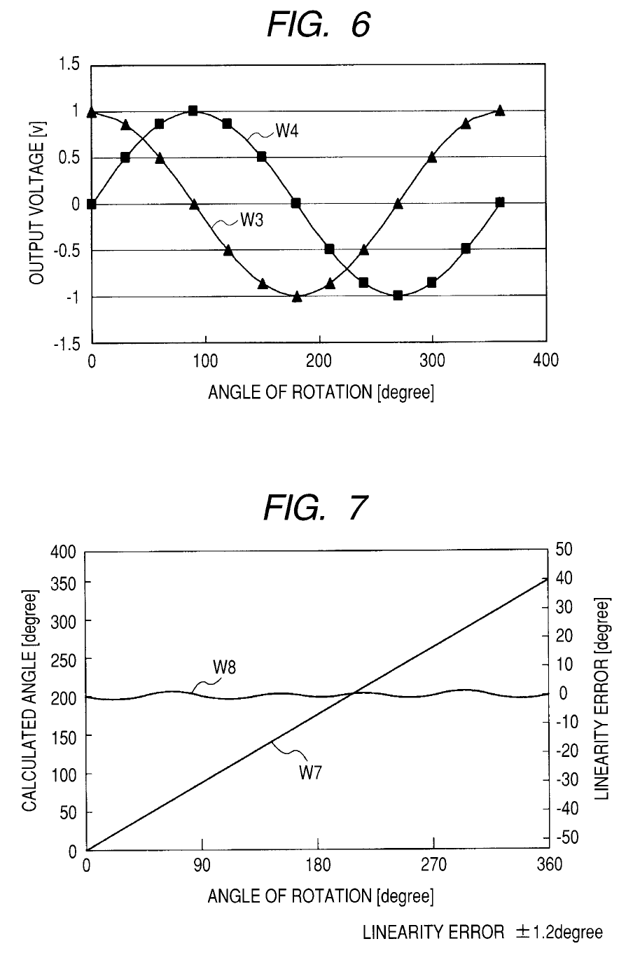

Hereinafter, the relationship between the output voltage and the phase when the hall element is inclined and disposed will be described with reference to FIG. 6. FIG. 6 is a view illustrating the relationship between the output voltage and the phase in the angle sensor according to the present embodiment. Moreover, in FIG. 6, the vertical axis indicates the output voltage and the horizontal axis indicates the angle of rotation of the magnet. In addition, a solid line W3 indicates an output voltage signal corresponding to the magnetic field strength of the Y-direction component, and a solid line W4 indicates an output voltage signal corresponding to the magnetic field strength of the X-direction component.

As shown in FIG. 6, the magnetic field strength of the Y-direction component detected by the hall element 4 becomes an output voltage signal of the cosine wave which has a maximum output voltage of 1 [v] and a minimum output voltage of −1 [v]. On the other hand, the magnetic field strength of the X-direction component detected by the hall element 4 becomes an output voltage signal of the sine wave which has a maximum output voltage of 1 [v] and a minimum output voltage of −1 [v]. Thus, the phase difference of 90° occurs between the output voltage signal corresponding to the magnetic field strength of the Y-direction component and the output voltage signal corresponding to the magnetic field strength of the X-direction component. Accordingly, since occurrence of the phase deviation caused by the mounting error of the hall element 4 can be prevented, the angle detection precision can be improved.

Next, when the arc tangent in the output voltage signals corresponding to the magnetic field strengths of the Y-direction component and X-direction component shown in FIG. 6 is calculated, the relationship between the angle of rotation of the magnet 2 and the calculated angle calculated by the operation section 16 is shown in FIG. 7. FIG. 7 is a view illustrating the linear characteristic of the angle sensor. Moreover, in FIG. 7, the vertical axis on the left side indicates the calculated angle, the vertical axis on the right side indicates the linear error, and the horizontal axis indicates the angle of rotation of the magnet. In addition, a solid line W7 indicates the linear characteristic and a solid line W8 indicates the error characteristic.

As shown in FIG. 7, the angle of rotation of the magnet 2 and the angle calculated by the operation section 16 have proportional relationship of about 1:1, and the linearity error is included in a range of ±1.2°. Accordingly, in the angle sensor 1 according to the present embodiment, it becomes possible to detect the angle of rotation of the magnet 2 on the basis of the detection signal from the hall element 4, without causing large angle deviation from the actual angle of rotation of the magnet 2.

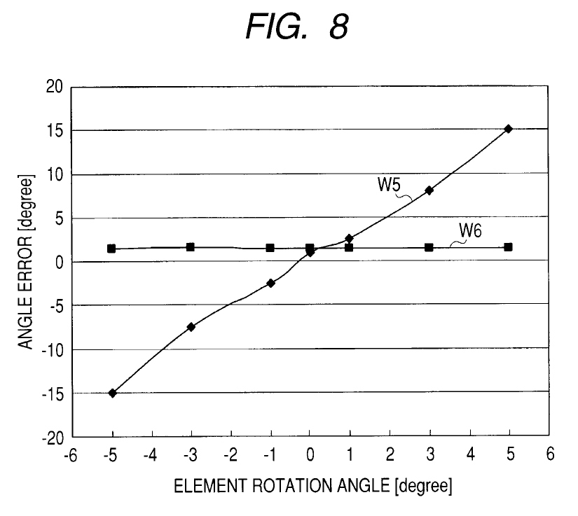

Referring to FIG. 8, the relationship between the element rotation angle of the hall element and the angle error in the angle sensor of the comparative example will be compared with that in the angle sensor according to the present embodiment. FIG. 8 is a view illustrating the relationship between the element rotation angle of the hall element and the angle error. Moreover, in FIG. 8, the vertical axis indicates the angle error and the horizontal axis indicates the element rotation angle of the hall element. In addition, a solid line W5 indicates the waveform generated by the angle sensor in the comparative example, and a solid line W6 indicates the waveform generated by the angle sensor according to the present embodiment.

As shown in FIG. 8, when the solid line W5 is compared to the solid line W6, the angle error increases as the angle of inclination of the hall element 24 increases in the case of the solid line W5, and a state where the angle error is small is kept constant even if the angle of inclination of the hall element 4 increases in the case of the solid line W6. Thus, the angle sensor 21 in the comparative example has an angle error of 15° when the angle of inclination of the hall element 24 is 5°, while the angle sensor 1 according to the present embodiment can keep an angle error of about 1° even if the angle of inclination of the hall element 4 is 5°.

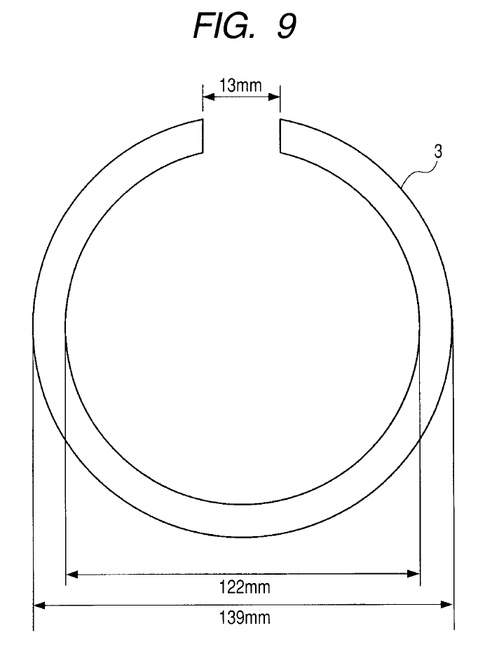

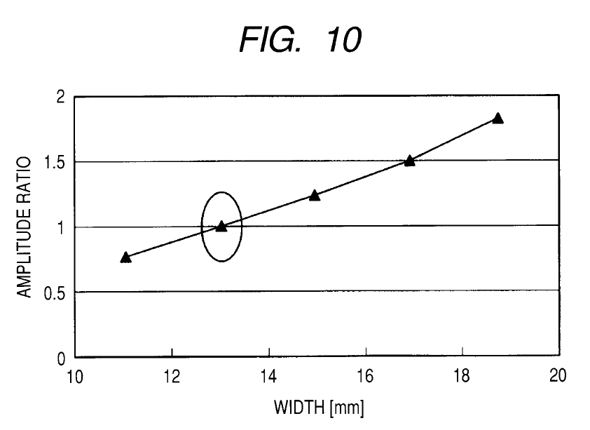

Next, a method of determining the gap width in the X direction of the notch portion will be described with reference to FIGS. 9 and 10. FIG. 9 is a view illustrating the design of an annular yoke, and FIG. 10 is a view illustrating the relationship between the width of the gap in the annular yoke shown in FIG. 9 and the amplitude ratio of the output voltages of the Y-direction component and X-direction component of the hall element. Moreover, in FIG. 10, the vertical axis indicates the amplitude ratio and the horizontal axis indicates the width of the gap in the notch portion 11.

As shown in FIG. 9, the annular yoke 3 is formed to have an internal diameter of 122 [mm] and an external diameter of 139 [mm]. In the angle sensor 1 using the annular yoke 3, as shown in FIG. 10, the width of the gap in the notch portion 11 at which the amplitude ratio, which is obtained by dividing the amplitude of the output voltage signal of the Y-direction component detected by the hall element 4 by the amplitude of the output voltage signal of the X-direction component, becomes 1 is about 13 [mm]. Accordingly, since the amplitude ratio between the output voltage signal of the Y-direction component and the output voltage signal of the X-direction component of the hall element 4 becomes 1 by setting the width of the notch portion 11 to 13 [mm], the strength of the magnetic field which acts on the hall element can be made constant regardless of the rotational position of the magnet 2.

In addition, assuming that the width of the gap in the notch portion 11 is L1 and the central diameter of the annular yoke 3 is L2, the width of the gap in the notch portion 11 satisfies the following expression (1).

L1=L2/10 (1)

The expression (1) indicates that the width of the gap in the notch portion 11 can be automatically determined by determining the central diameter of the annular yoke 3.

In the present embodiment, the external diameter of the annular yoke 3 is 139 [mm] and the internal diameter of the annular yoke 3 is 122 [mm]. Since the central diameter of the annular yoke 3 is a half of the sum of the external diameter and the internal diameter, the central diameter becomes 130.5 [mm]. Since the width of the gap in the notch portion 11 is 1/10 of the central diameter, the width of the gap becomes 13.05 [mm], which is approximately the same size as the above-described 13 [mm].

As described above, according to the angle sensor 1 of the present embodiment, the strength of the magnetic field which acts on the hall element 4 can be made constant regardless of the rotational position of the magnet 2 by forming the magnetic path with the annular yoke 3 in which the notch portion 11 is formed. Accordingly, even if the hall element 4 is inclined and attached, the phase difference between signals corresponding to the Y-direction and X-direction magnetic field strengths detected by the hall element 4 can be set to 90°. As a result, the high angle detection precision can be secured regardless of the mounting accuracy of the hall element 4.

In addition, since the notch portion 11 is formed such that the strength of the magnetic field, which acts on the hall element 4 according to the rotation of the magnet 2, is constant, it is not necessary to perform the electrical amplitude correction such that the amplitudes of the signals corresponding to the Y-direction and X-direction magnetic field strengths are made to be equal. As a result, the angle sensor 1 can have a simple control configuration.

Moreover, although the width of the gap in the notch portion 11 is set to 1/10 of the central diameter of the annular yoke 3 in the embodiment described above, it is also possible to form the angle sensor 1 with good angle detection precision if the width of the gap in the notch portion 11 is in the range of ⅛ to 1/12 of the central diameter of the annular yoke 3.

Next, another embodiment of the invention will be described. An angle sensor according to another embodiment of the invention is different from the angle sensor according to the above-described embodiment in that a notch portion for adjustment of magnetic resistance of a magnetic path is provided in addition to a notch portion for disposition of a hall element. Accordingly, only the different point will be described in detail.

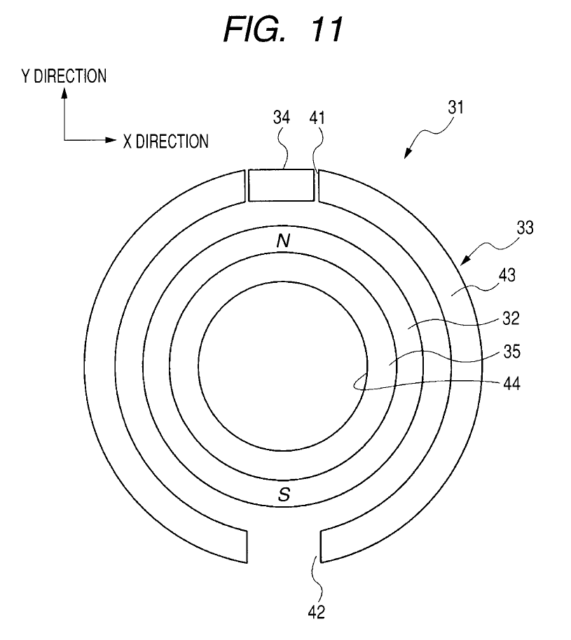

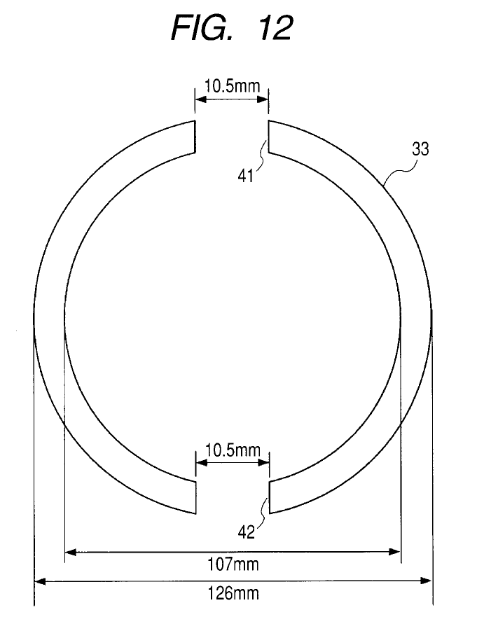

Referring to FIGS. 11 and 12, the angle sensor according to another embodiment of the invention will be described. FIG. 11 is a schematic view illustrating the angle sensor according to another embodiment of the invention. FIG. 12 is a view illustrating the design of an annular yoke according to another embodiment of the invention.

As shown in FIG. 11, an angle sensor 31 according to the present embodiment is configured to include: a magnet 32 having a circular shape; an annular yoke 33 which surrounds the outer peripheral surface of the magnet 32 and in which the first and second notch portions 41 and 42 are formed at the opposite positions with the center of the magnet 32 interposed therebetween; and a hall element 34 disposed in the first notch portion 41 of the annular yoke 33. A circular mounting member 35 is disposed on the inner peripheral surface of the magnet 32, and a mounting hole 44 through which a crankshaft (not shown) can be inserted is formed in the middle of the mounting member 35.

The annular yoke 33 is formed by providing the first and second notch portions 41 and 42 at the opposite positions of a circular portion 43. In addition, the circular portion 43 and first and second notch portions 41 and 42 of the annular yoke 33 form the magnetic path of the magnetic field generated by the magnet 32. The strength of the magnetic field which acts on the hall element 34 is kept constant regardless of the angle of rotation of the magnet 32 by the first notch portion 41, and the magnetic resistance of the magnetic path in the annular yoke 33 is adjusted by the second notch portion 42. In addition, the first and second notch portions 41 and 42 are formed such that the gap widths thereof are equal, and the magnetic resistance of the magnetic path generated when the magnetic flux passes through the first notch portion 41 of the annular yoke 33 and the magnetic resistance of the magnetic path generated when the magnetic flux passes through the second notch portion 42 are adjusted to be equal.

In this case, the widths of the gaps in the first and second notch portions 41 and 42 are set to be slightly smaller than the length corresponding to 1/10 of the central diameter of the annular yoke 33. In the present embodiment, as shown in FIG. 12, the external diameter of the annular yoke 33 is set to 126 [mm], the internal diameter of the annular yoke 33 is set to 107 [mm], and the widths of the gaps in the first and second notch portions 41 and 42 are set to 10.5 [mm]. The widths of the gaps in the first and second notch portions 41 and 42 correspond to about 1/11 of the central diameter of the annular yoke 33.

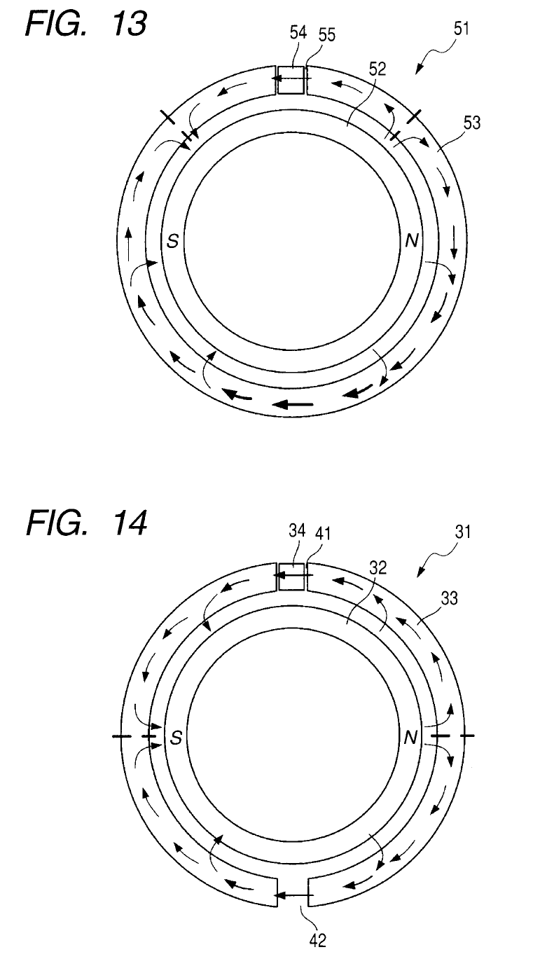

Next, flow of magnetic flux in the annular yoke will be described with reference to FIGS. 13 and 14. FIG. 13 is a view for explaining the flow of magnetic flux of an angle sensor in a comparative example for comparison with the angle sensor according to another embodiment of the invention. FIG. 14 is a view for explaining the flow of magnetic flux of the angle sensor according to another embodiment of the invention.

First, the flow of magnetic flux of the angle sensor in the comparative example will be described. As shown in FIG. 13, in an angle sensor 51 of the comparative example, a notch portion 55 is formed only in a part and a hall element 54 is disposed in the notch portion 55. In this case, since the notch portion 55 is formed only in a part of an annular yoke 53, a large difference of magnetic resistance occurs between the magnetic path in which the magnetic flux flows back through the notch portion 55 (hall element 54) and the magnetic path in which the magnetic flux flows back without the notch portion 55 when the magnetic pole of a magnet 52 does not exist at the opposite position of the notch portion 55.

Accordingly, since the magnetic resistance of the magnetic path in which the magnetic flux flows back without the notch portion 55 is lower than the magnetic path in which the magnetic flux flows back through the notch portion 55, a turning point of the magnetic path in the annular yoke 53 shown in the broken line is located to be closer to the notch portion 55 with respect to the magnetic axis which connects both the magnetic poles of the magnet 52. Accordingly, since the magnetic flux is pulled in the direction in which the magnetic resistance is low in the annular yoke 53, the magnetic flux flowing through the side of the notch portion 55 is decreased. As a result, the magnetic flux which acts on the hall element 54 disposed in the notch portion 55 is decreased, which lowers the detection sensitivity. On the other hand, the magnetic flux flowing through the opposite side of the notch portion 55 is increased. Accordingly, the magnetic flux may be saturated at the opposite side of the notch portion 55 with the center of the magnet 52 interposed therebetween in the annular yoke 53. As a result, the magnetic flux may leak to the outside of the annular yoke 53.

Thus, in the angle sensor 51 of the comparative example, the high angle detection precision can be secured regardless of the mounting accuracy of the hall element 54 by disposing the hall element 54 in the notch portion 55 of the annular yoke 53, but it is difficult to obtain the sufficient detection sensitivity.

On the other hand, as shown in FIG. 14, in the angle sensor 31 according to the present embodiment, the first and second notch portions 41 and 42 are formed to have the same gap width at the opposite positions with the magnet 32 interposed therebetween. In this case, even when the magnetic poles of the magnet 32 are not located at the opposite positions of the first and second notch portions 41 and 42, the magnetic resistance of the magnetic path in which the magnetic flux flows back through the first notch portion 41 (hall element 34) is the same as that of the magnetic path in which the magnetic flux flows back through the second notch portion 42.

Accordingly, in the annular yoke 33, a turning point of the magnetic path in the annular yoke 33 is located on the extension of the magnetic axis of the magnet 32 since the magnetic resistance in the magnetic path on the side of the first notch portion 41 is equal to that in the magnetic path on the side of the second notch portion 42. As a result, a decrease in the magnetic flux which flows through the side of the first notch portion 41 in the annular yoke 33 is suppressed and the magnetic flux which acts on the hall element 34 disposed in the first notch portion 41 is increased, which improves the detection sensitivity. On the other hand, the magnetic flux which flows through the side of the second notch portion 42 is decreased and saturation of the magnetic flux on the side of the second notch portion 42 is suppressed. As a result, leakage of the magnetic flux can be prevented.

Thus, in the angle sensor according to the present embodiment, the angle detection precision can be improved by forming the first and second notch portions 41 and 42 in the annular yoke 33 and disposing the hall element 34 in the first notch portion 41. In addition, it becomes possible to improve the detection sensitivity by eliminating the biasing of magnetic flux density on the sides of the first and second notch portions 41 and 42 of the annular yoke 33.

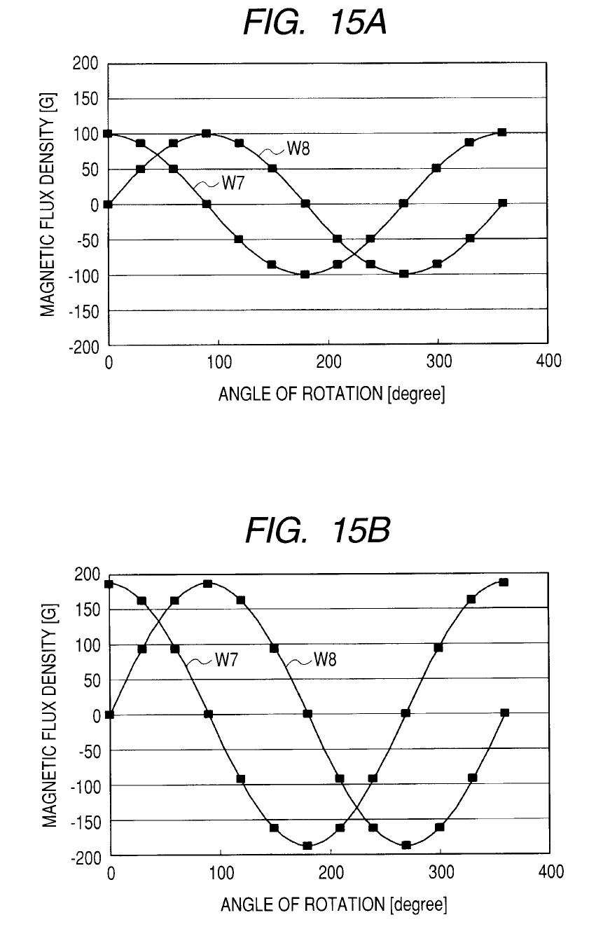

In this case, the variation width of the magnetic flux density to the angle of rotation of the angle sensor in the comparative example and the variation width of the magnetic flux density to the angle of rotation of the angle sensor according to the present embodiment are shown in FIGS. 15A and 15B, respectively. FIG. 15A is a view illustrating the sensitivity characteristic of the angle sensor in the comparative example, and FIG. 15B is a view illustrating the sensitivity characteristic of the angle sensor according to the present embodiment. Moreover, in FIGS. 15A and 15B, the vertical axis indicates the magnetic flux density and the horizontal axis indicates the angle of rotation of the magnet. In addition, a solid line W7 indicates the Y-direction component of the magnetic flux which acts on the hall element, and a solid line W8 indicates the X-direction component of the magnetic flux which acts on the hall element.

As shown in FIGS. 15A and 15B, the variation width of the magnetic flux density of the angle sensor 51 in the comparative example is about 200 [G], and the variation width of the magnetic flux density of the angle sensor 31 according to the present embodiment is about 380 [G]. Thus, in the angle sensor 31 according to the present embodiment, the variation width of the magnetic flux density is about twice compared with the angle sensor 51 in the comparative example. As a result, the detection sensitivity is doubled.

As described above, according to the angle sensor 31 of the present embodiment, the strength of the magnetic field which acts on the hall element 34 can be made constant regardless of the rotational position of the magnet 32 by forming the magnetic path with the annular yoke 33 in which the first and second notch portions 41 and 42 are formed. Accordingly, even if the hall element 34 is inclined and attached, the phase difference between signals corresponding to the Y-direction and X-direction magnetic field strengths detected by the hall element 34 can be set to 90°. As a result, high angle detection precision can be secured regardless of the mounting accuracy of the hall element 34. In addition, since the magnetic resistance of the magnetic path on the side of the first notch portion 41 of the annular yoke 33 is equal to the magnetic resistance of the magnetic path on the side of the second notch portion 42, biasing of the magnetic flux density in the annular yoke 33 can be eliminated. Accordingly, it is possible to improve the detection sensitivity by suppressing the decrease in the magnetic flux, which acts on the hall element 34, and to prevent leakage of the magnetic flux.

Moreover, although the width of the gap in the notch portion 55 is set to 1/11 of the central diameter of the annular yoke 33 in another embodiment described above, it is also possible to form the angle sensor 31 with a good angle detection precision if the width of the gap in the notch portion 55 is in the range of ⅛ to 1/12 of the central diameter of the annular yoke 33.

In addition, although the configuration where the first and second notch portions 41 and 42 are formed in the annular yoke 33 is adopted in another embodiment described above, the invention is not limited to such a configuration. It is possible to adopt any configuration where the magnetic resistance of the magnetic path in which the magnetic flux flows in one direction of the annular yoke 33 is approximately equal to the magnetic resistance of the magnetic path in which the magnetic flux flows in the opposite direction. For example, a configuration where three or more notch portions are formed in the annular yoke 33 may also be adopted.

In addition, although the configuration where the first and second notch portions 41 and 42 are formed to have the same gap width at the opposite positions of the annular yoke 33 is adopted in another embodiment described above, the invention is not limited to such a configuration. It is possible to adopt any configuration where the magnetic resistance of the magnetic path on the side of the first notch portion 41 is equal to that of the magnetic path on the side of the second notch portion 42. For example, the width of the gap in the second notch portion 42 may be larger than the width of the gap in the first notch portion 41.

In addition, the magnetic resistance of the magnetic path in which the magnetic flux flows in one direction does not need to be approximately or completely equal to the magnetic resistance of the magnetic path in which the magnetic flux flows in the opposite direction, and it is preferable that the magnetic resistances of the magnetic paths be close to each other to the extent that the decrease in the magnetic flux which acts on the hall element 34 can be suppressed and the leakage of the magnetic flux from the annular yoke 33 can be prevented.

In addition, although the magnets 2 and 32 and the annular yokes 3 and 33 are formed in the circular shape in another embodiment described above, the invention is not limited to such a configuration. As long as a configuration where the strength of the magnetic field which acts on the hall elements 4 and 34 is constant regardless of the rotation angle of the magnets 2 and 32 is adopted, the polygonal annular shape may also be applied. In addition, the annular yokes 3 and 33 may be partially cut as long as a configuration where the magnetic path is not interrupted and the strength of the magnetic field, which acts on the hall elements 4 and 34, is constant regardless of the rotation angle of the magnets 2 and 32 is adopted.

In addition, the embodiments disclosed herein are only illustrative, and the invention is not limited to the embodiments. The range of the invention is illustrated by the appended claims not by the explanation only in the above embodiments, and all kinds of changes may be made without departing from the subject matter or spirit of the invention defined by the appended claims and their equivalents.

As described above, the invention is effective in that the high angle detection precision can be secured regardless of the mounting accuracy of the magnetic detection element and the simple control configuration can be adopted. In particular, the invention is useful for an angle sensor to which high angle detection precision is requested.

What is claimed is:

1. An angle sensor comprising:
a magnet which is attached to a rotary body and which is rotatable together with the rotary body;
an annular yoke which extends annularly to surround an outer peripheral surface around a rotary shaft of the magnet and in which a notch portion is formed in a part in the extending direction;
a magnetic detection element which is disposed in the notch portion and which detects the strength of a magnetic field in the radial direction of the magnet and detects the strength of a magnetic field in the rotation angle direction perpendicular to the magnetic field in the radial direction of the magnet; and
an operation unit that calculates the angle of rotation of the magnet on the basis of signals corresponding to the magnetic field strengths in the radial direction and rotation angle direction detected by the magnetic detection element.

2. The angle sensor according to claim 1,
wherein the width of the gap in the notch portion is set such that the amplitude ratio between the signals corresponding to the magnetic field strengths in the radial direction and rotation angle direction detected by the magnetic detection element becomes 1.

3. The angle sensor according to claim 1,
wherein the annular yoke is formed in a circular shape, and
the width of the gap in the notch portion is ⅛ to 1/12 of the central diameter of the annular yoke.

4. The angle sensor according to claim 3,
wherein the width of the gap in the notch portion is 1/10 of the central diameter of the annular yoke.

5. An angle sensor comprising:
a magnet which is attached to a rotary body and which is rotatable together with the rotary body;
an annular yoke which extends annularly to surround an outer peripheral surface around a rotary shaft of the magnet and in which a plurality of notch portions is formed in the extending direction;
a magnetic detection element which is disposed in one of the plurality of notch portions and which detects the strength of a magnetic field in the radial direction of the magnet and detects the strength of a magnetic field in the rotation angle direction perpendicular to the magnetic field in the radial direction of the magnet; and
an operation unit that calculates the angle of rotation of the magnet on the basis of signals corresponding to the magnetic field strengths in the radial direction and rotation angle direction detected by the magnetic detection element.

6. The angle sensor according to claim 5,
wherein the plurality of notch portions is formed in the annular yoke such that the magnetic resistance of a magnetic path in which the magnetic flux flows in one direction of the annular yoke is approximately equal to the magnetic resistance of a magnetic path in which the magnetic flux flows in the opposite direction.

7. The angle sensor according to claim 5,
wherein the number of plurality of notch portions is two, and
the two notch portions are formed approximately at opposite positions with the rotation center of the magnet interposed therebetween in the annular yoke.

8. The angle sensor according to claim 7,
wherein the widths of the gaps in the two notch portions are set such that the amplitude ratio between the signals corresponding to the magnetic field strengths in the radial direction and rotation angle direction detected by the magnetic detection element becomes 1.

9. The angle sensor according to claim 7,
wherein the annular yoke is formed in a circular shape, and
the widths of the gaps in the two notch portions are ⅛ to 1/12 of the central diameter of the annular yoke.
